(19) United States
(12) Patent Application Publication
(10) Pub. No.: US 2015/0249636 A1
(43) Pub. Date: Sep. 3, 2015

(54) RESOURCE DOWNLOAD METHOD, SERVICE SERVER AND CELLULAR PHONE CLIENT

(71) Applicant: TENCENT TECHNOLOGY (SHENZHEN) COMPANY LIMITED, Shenzhen Guangdong (CN)

(72) Inventors: Shengwei Lin, Shenzhen Guangdong (CN); Difei Zou, Shenzhen Guangdong (CN); Deliang Zhu, Shenzhen Guangdong (CN); Yusheng Zhong, Shenzhen Guangdong (CN); Xing Shao, Shenzhen Guangdong (CN); Zhenyu Wu, Shenzhen Guangdong (CN)

(73) Assignee: TENCENT TECHNOLOGY (SHENZHEN) COMPANY LIMITED, Shenzhen Guangdong (CN)

(21) Appl. No.: 14/713,595

(22) Filed: May 15, 2015

Related U.S. Application Data
(63) Continuation of application No. PCT/CN2013/078599, filed on Jul. 1, 2013.

(30) Foreign Application Priority Data
Nov. 19, 2012 (CN) 201210467911.6

(51) Int. Cl. H04L 29/12; H04W 8/26; H04W 64/00; H04L 29/06

(52) U.S. Cl. CPC H04L 61/1511; H04L 67/42; H04W 8/26; H04W 64/006

(57) ABSTRACT

A resource download method, a service server, and a cellular phone client are described. The service server may determine a geographic area where the cellular phone client is located and an operator to which the cellular phone client belongs to according to an IP address of the cellular phone client received from the cellular phone client. The service server may determine an IP address of a download server according to the geographic area and the operator. The service server may subsequently send the IP address of the download server to the cellular phone client, which may download the resource.

### CROSS-REFERENCE TO RELATED APPLICATIONS

The present application claims the benefit and is a continuation of PCT/CN2013/078599, filed on Jul. 1, 2013 and entitled “RESOURCE DOWNLOAD METHOD, SERVICE SERVER AND CELLULAR PHONE CLIENT”, which claims priority to Chinese Patent Application No. 201210467911.6, filed with Chinese Patent Office on Nov. 19, 2012 and entitled “RESOURCE DOWNLOAD METHOD, SERVICE SERVER AND CELLULAR PHONE CLIENT”, which are incorporated herein by reference in their entireties.

### FIELD OF THE TECHNOLOGY

The present disclosure relates to the field of communications technologies.

### BACKGROUND OF THE DISCLOSURE

Currently, a domain name resolution server performs domain name system (DNS) resolution according to a domain name in a download address that is sent by a mobile phone client and includes the domain name, and determines an Internet Protocol (IP) address of a download server of the mobile phone client according to a resolution result, so as to implement a resource download. However, such a manner of downloading a resource is limited to a data caching function of a domain name resolution server.

### SUMMARY

The present disclosure provides a resource download method, a service server, and a mobile phone client.

According to a first aspect of the present disclosure, a resource download method is provided. The resource download method, may include determining, by a service server, according to an internet protocol (IP) address of a mobile phone client obtained from the mobile phone client, a geographical area where the mobile phone client is located and an operator to which the mobile phone client belongs. The resource download method also may also include determining, by the service server, an IP address of a download server according to the geographical area and the operator. The resource download method also include sending, by the service server, the IP address of the download server for receipt by the mobile phone client, so as to implement a resource download at the mobile phone client.

According to a second aspect of the present disclosure, a resource download method is provided, which includes sending, by a mobile phone client, an internet protocol (IP) address of the mobile phone client to a service server. The resource download method also includes receiving, by the mobile phone client, an IP address of a download server sent by the service server, where the IP address of the download server is determined according to a geographical location of the mobile phone client and an operator of the mobile phone client, and where the geographical location of the mobile phone client and the operator of the mobile phone client are determined based on the IP address of the mobile phone client.

According to a third aspect of the present disclosure, a service server is provided, which includes a first determination module, configured to determine, according to an internet protocol (IP) address of a mobile phone client received from the mobile phone client, a geographical area where the mobile phone client is located and an operator of the mobile phone client. The service server also includes a second determination module configured to determine an IP address of a download server according to the geographical area and the operator. The service server also includes a sending module configured to send the IP address of the download server to the mobile phone client.

According to a fourth aspect of the present disclosure, a mobile phone client is provided, which may include a sending module configured to send an IP address of the mobile phone client to a service server. The mobile phone client may also include a receiving module configured to receive an IP address of a download server sent by the service server, where the IP address of the download server is determined according to a geographical area where the mobile phone client is located and an operator to which the mobile phone client belongs, and the geographical area where the mobile phone client is located and the operator to which the mobile phone client belongs are determined according to the IP address of the mobile phone client.

According to a fifth aspect of the present disclosure, a resource download system is provided, which may include a service server, a mobile phone client, and a download server.

According to the technical solutions proposed by the present disclosure, a service server may determine, according to an IP address of a mobile phone client, a geographical area in which the mobile phone client is located. The service server may additionally determine an operator to which the mobile phone client belongs. The service server may determine an IP address of a download server based on the obtained geographical area and operator. The service server may send the IP address of the download server to the mobile phone client, so as to implement a resource download. The service server may determine, based on the geographical area where the mobile phone client is located and the operator to which the mobile phone client belongs, the IP address of the download server that provides the mobile phone client with a download service. Thus, the service server may not obtain an IP address of the download server in a manner of DNS resolution by using a domain name resolution server. Accordingly, success rate and speed of resource downloading of the mobile phone client is improved.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 is a schematic diagram of a flowchart of an example resource download method;

FIG. 2 is a schematic diagram of a flowchart of an example resource download method;

FIG. 3 is a schematic diagram of a flowchart of an example resource download method;

FIG. 4 is a schematic structural diagram of an example service server;

FIG. 5 is a schematic structural diagram of an example service server;

FIG. 6 is a schematic structural diagram of an example mobile phone client;

FIG. 7 is a schematic structural diagram of an example mobile phone client; and

FIG. 8 is a schematic structural diagram of an example resource download system.

### DESCRIPTION OF EMBODIMENTS

According to a resource download method, a service server, and a mobile phone client described throughout the present document, the mobile phone client may obtain an IP address of a download server by using a service server. The technical solutions described throughout the present document improve the success rate and speed of resource downloading by the mobile phone client by avoiding to obtain an IP address of the download server using DNS resolution based on a domain name resolution server.

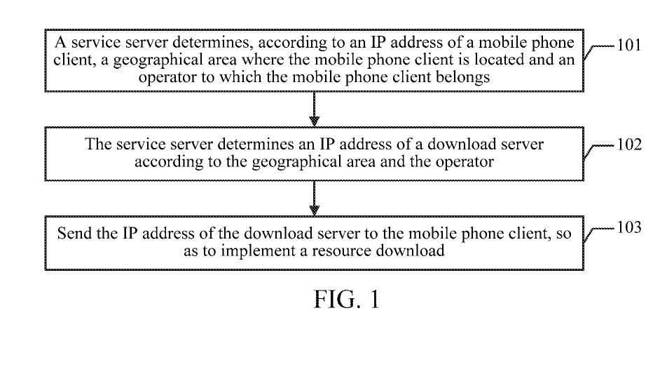

FIG. 1 illustrates a flowchart of an example resource download method, which includes at least steps 101 to 103.

In step 101, a service server may determine, according to an IP address of a mobile phone client obtained from the mobile phone client, a geographical area where the mobile phone client is located and an operator to which the mobile phone client belongs.

In an example, the service server may receive a link request sent by the mobile phone client. The link request may include the IP address of the mobile phone client. In an example, the IP address of the mobile phone client may be allocated to the mobile phone client by the operator. For example, when the mobile phone client enters a network of an operator, the operator may allocate the IP address to the mobile phone client. The mobile phone client may implement data interaction with the service server and a download server by using the IP address allocated by the operator to the mobile phone client.

The service server may determine, according to the IP address of the mobile phone client, the geographical area where the mobile phone client is located and the operator to which the mobile phone client belongs. For example, the geographical area where the mobile phone client is located may include an area where an operator gateway is located when the mobile phone client enters the network. The operator to which the mobile phone client belongs may include an operator to which a Subscriber Identity Module (SIM) card of the mobile phone client belongs. For example, the operator may be any one of China Mobile, China Unicom, China Telecom, China Netcom, AT&T, Verizon, Sprint, T-Mobile, or any other service provider.

In step 102, the service server may determine an IP address of the download server according to the determined geographical area and operator.

For example, upon determining the geographical area where the mobile phone client is located and the operator to which the mobile phone client belongs, the service server may determine the IP address of the download server according to the geographical area and the operator.

In step 103, the IP address of the download server may be sent to the mobile phone client. The mobile phone client may subsequently obtain a download address by using the IP address of the download server, so as to implement a resource download.

For example, upon acquiring the IP address of the download server, the service server may send the obtained IP address of the download server to the mobile phone client. The mobile phone client, in response to receiving the IP address of the download server, may obtain the download address of the resource by using the IP address of the download server. The mobile phone client may download the resource based on the download address thus obtained.

Thus, the service server may determine, by using the IP address of the mobile phone client, the geographical area where the mobile phone client is located and the operator to which the mobile phone client belongs. The service server may determine, by using the determined geographical area and operator, the IP address of the download server that may provide the mobile phone client with a download service. The service server may send the IP address of the download server to the mobile phone client. The mobile phone client may download the resource based on the IP address of the download server. The technical solution of determining an IP address of the download server described, by using the geographical area and the operator, thus avoids caching function of a domain name resolution server. Thus, the success rate and speed of resource downloading by the mobile phone client is effectively improved.

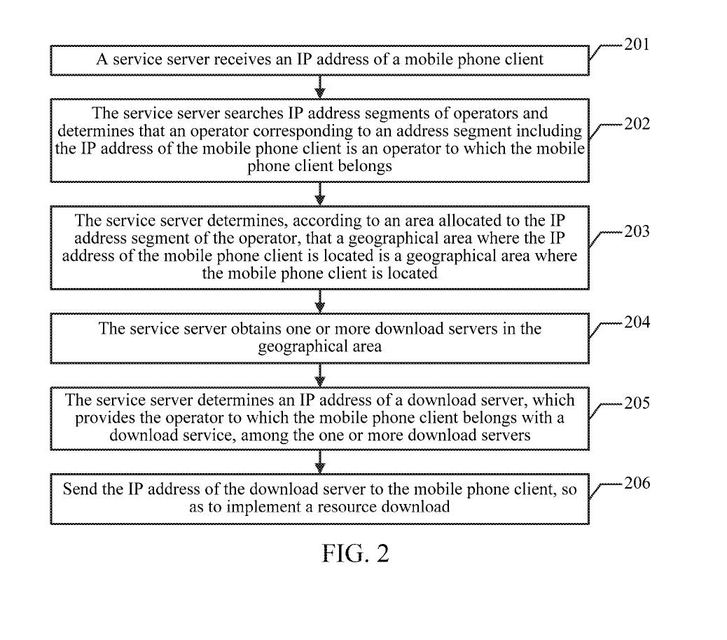

FIG. 2 illustrates a flowchart of an example resource download method, which includes at least steps 201 to 206.

In step 201, a service server may receive an IP address of a mobile phone client.

For example, the service server may receive a link request sent by the mobile phone client. The link request may include the IP address of the mobile phone client. The IP address of the mobile phone client may be allocated to the mobile phone client by an operator. For example, when a mobile phone client enters a network of the operator, the operator may allocate the IP address to the mobile phone client. The mobile phone client may implement data communication, such as with the service server and a download server, by using the IP address allocated by the operator to the mobile phone client.

In step 202, the service server may search IP address segments of multiple operators and determine that an operator corresponding to an address segment including the IP address of the mobile phone client is the operator to which the mobile phone client belongs.

For example, each operator may have a corresponding IP address segment. The operator may allocate an IP address within the corresponding IP address segment to the mobile phone client that is connected to the network of the operator. The mobile phone client may subsequently perform data communication with a server in the network of the operator by using the allocated IP address.

The service server may search IP address segments of operators and determine that an operator corresponding to an address segment including the IP address of the mobile phone client is the operator to which the mobile phone client belongs. For example, assume that 111.0.0.0/10 is an IP address segment of a provider, such as China Mobile. If the IP address of the mobile phone client is 111.0.0.7, it may be identified that the operator to which the mobile phone client belongs is China Mobile.

In step 203, the service server may determine, according to an area allocated to the IP address segment of the operator, a geographical area where the mobile phone client is located.

Thus, the service server may determine, by using the IP address of the mobile phone client in the link request, the geographical area where the mobile phone client is located. For example, the service server may determine, according to the area allocated to the IP address segment to which the IP address of the mobile phone client belongs, the geographical area where the IP address of the mobile phone client belongs. Continuing the previous example, where the IP address allocated to the mobile phone client by China Mobile is 111.0.0.7, where the IP address is one in the IP address segment 111.0.0.0/10 of China Mobile, if the IP address segment is allocated to Shenzhen area, it may be identified that the geographical area where the mobile phone client is located in Shenzhen.

In step 204, the service server may obtain one or more download servers in the determined geographical area.

In step 205, the service server may determine an IP address of a download server among the obtained one or more download servers that provides a download service to the operator to which the mobile phone client belongs.

For example, assuming that the geographical area where the mobile phone client A is located is Shenzhen and the operator to which the mobile phone client belongs is China Mobile. The service server may determine all download servers such as download servers B, C, D, E, and F in Shenzhen. The service server may further determine that a subset of download servers, which can provide a user of China Mobile with a download service. For example, among the download servers B to F in the Shenzhen geographic area only download servers C and E may serve clients of China Mobile.

Thus, by using steps 204 and 205, a download server that is in the same geographical area as the mobile phone client and that serves the operator of the mobile phone client may be identified. Further, the service server may facilitate the identified download server to provide the mobile phone client with a download service. Accordingly, a desirable, and more efficient download path may be obtained. Further, ‘nearby downloading’ may be implemented, so as to improve a download speed, due to closer geographic proximity in this case. In an example, the identified download server may belong to the same operator to which the mobile client belongs.

If the service server determines more than one download server in the same geographic area of the mobile phone client and that serves the operator, the service server may select a download server from the identified set of servers. For example, the service server may select a download server that has a predetermined service capability, or distance from the mobile phone client below a predetermined threshold, or using any other criteria. The service server may send an IP address of the selected download server to the mobile phone client. The mobile phone client may, in response, acquire a desirable download path to the download server. Thus, a download speed can be improved and a download path can be optimized effectively.

In step 206, the IP address of the download server is sent to the mobile phone client. Therefore, the mobile phone client may subsequently obtain a download address by using the IP address of the download server, so as to implement a resource download.

After determining the IP address of the download server that can provide the mobile phone client with a download service, the service server may send the obtained IP address of the download server to the mobile phone client. Upon receiving the IP address of the download server, the mobile phone client may obtain the download address by using the IP address of the download server, so as to implement a resource download.

In an example, the service server may search IP address segments of operators to determine the operator corresponding to an address segment including the IP address of the mobile phone client. Alternatively or in addition, the service server may determine, by using the IP address of the mobile phone client, the geographical area where the mobile phone client is located. Further, the service server may determine an IP address of the download server that is in the same geographical area as the mobile phone client and that belongs to the operator as the mobile phone client. The service server may return the obtained IP address of the download server to the mobile phone client. Accordingly, a problem of a download failure or a slow speed caused by using a domain name resolution server to perform domain name resolution and acquire the IP address of the download server is avoided. Consequently, success rate and speed of resource downloading by the mobile phone client is effectively improved.

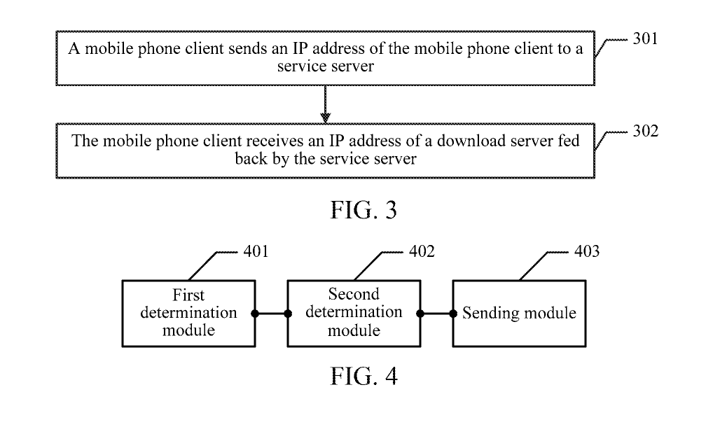

In the embodiments shown in FIG. 1 and FIG. 2, the resource download method of a mobile phone client is described from the perspective of a service server, and the resource download method of a mobile phone client is described below from the perspective of the mobile phone client. FIG. 3 illustrates a flowchart of an example resource download method, which includes at least steps 301 and 302.

In step 301, a mobile phone client may provide a service server with an IP address of the mobile phone client.

When the mobile phone client has to download a resource from a network, the mobile phone client may send a link request to the service server. The link request may serve as a request to obtain a download address of the resource. In an example, the mobile phone client may add the IP address of the mobile phone client to the link request. Upon receiving the link request, the service server can perform the steps illustrated in FIG. 1 or FIG. 2, and return the IP address of the download server that is in the same geographical area as the mobile phone client and that serves the same operator as the mobile phone client. In another example, the download server may even belong to the same operator as the mobile phone client.

In step 302, the mobile phone client may receive the IP address of the download server from the service server. The service provider may determine the IP address of the download server according to the geographical area where the mobile phone client is located and the operator to which the mobile phone client belongs. The geographical area where the mobile phone client is located and the operator to which the mobile phone client belongs may be determined according to the IP address of the mobile phone client.

The mobile phone client may subsequently determine a download address of the resource based on the IP address of the download server The mobile phone client may use the download address to implement a resource download.

The mobile phone client may implement different steps to determine the download address depending on whether the service server sends one or multiple IP address of download server(s) to implement the resource download.

For example, if only one IP address of the download server exists in the received IP address of the download server, the mobile phone client may replace a domain name of the download server in a download address of the resource with the IP address of the download server. For example, assuming that an IP address of a download server is 192.168.10.10, and a download address having a domain name is: http://www.qq.com/android/soft/name.apk, the domain name www.qq.com in the download address may be replaced with 192.168.10.10, so that the obtained download address is http://192.168.10.10/android/soft/name.apk. The mobile phone client may accordingly initiate a download request to the download address, so as to implement the resource download.

The download address having the domain name may include an address obtained during networking between the service server and the mobile phone client during use, for example, an address corresponding to a page opened when a mobile phone client uses a mobile phone browser.

In an example, the mobile phone client may determine the download address according to the received IP address of the download server and implements the resource download. For example, if more than one download server exists, the mobile phone client may select an IP address of one download server from the list of IP addresses. The mobile phone client may use the IP address of the selected download server to replace a domain name in the download address having the domain name, so as to obtain the download address for the resource download. The mobile phone client may select the download server based on a predetermined criteria such as thresholds associated with bandwidth availability, geographic distance, download costs, or any other criteria.

The mobile phone client may provide the service server with the IP address of the mobile phone client itself, so that the service server may send, to the mobile phone client, the IP address of the download server that is in the same geographical area as the mobile phone client and belongs to the same operator as the mobile phone client. The mobile phone client may determine the download address by using the received IP address of the download server, so as to implement the resource download. Thus, the mobile client may skip obtaining an IP address of the download server, such as by using DNS resolution, which may include using a domain name resolution server. Accordingly, the mobile phone client may avoid a failure in downloading the resource. Further, the mobile phone client may download the resource at a relatively faster speed due to geographic proximity in comparison to downloading from a download server farther away from the geographic location of the mobile phone client. Thus, the technical solution provide an improved success rate and speed of downloading the requested resource.

Consider the following example. A mobile phone client A may send a link request to a service server B, where the link request includes an IP address 111.0.0.7 allocated to the mobile phone client by an operator, say China Mobile. After receiving the link request, the service server B may search IP address segments of operators and may determine that the IP address 111.0.0.7 belongs to an IP address segment 111.0.0.0/10. The service server B may further determine that the IP address segment belongs to China Mobile. Next, the service server B may search areas allocated to the IP address segment 111.0.0.0/10 and may determine that the IP address segment is allocated to the Shenzhen district. Accordingly, the service server B may determine that the mobile phone client A is located in the Shenzhen district geographical area. Next, the service server B may determine that the Shenzhen district includes download servers C, D, E, F, and G. The service server B may identify download servers from the download servers in Shenzhen that serves the operator China Mobile, and identify the IP addresses of such download servers. For example, if the download server E is the only download server that can provide a user of China Mobile with a download service, the IP address of the download server E is identified, say 221.130.0.12. The service server B may send the IP address 221.130.0.12 to the mobile phone client A. After receiving the IP address 221.130.0.12 sent by the service server B, the mobile phone client A may replace a domain name, such as www.qq.com in a download address http://www.qq.com/android/soft/name.apk with the IP address. Thus, in this case the mobile phone client A may obtain the download address http://221.130.0.12/android/soft/name.apk. The mobile phone client A may subsequently initiate a download request to the generated download address, so that content of the resource are downloaded.

FIG. 4 illustrates an example service server. The service server may include a first determination module 401, a second determination module 402.

The first determination module 401 may determine, according to an IP address of a mobile phone client obtained from the mobile phone client, a geographical area where the mobile phone client is located and an operator to which the mobile phone client belongs.

The second determination module 402 may determine, according to the determined geographical area and operator, an IP address of a download server.

The sending module 403 may send the IP address of the download server to the mobile phone client. The mobile phone client subsequently may obtain a download address by using the IP address of the download server, so as to implement a resource download.

The service server may further include a receiving module (not shown) that may receive a link request sent by the mobile phone client. The link request may include the IP address of the mobile phone client.

In an example, the first determination module 401 may determine, according to the IP address of the mobile phone client, the geographical area where the mobile phone client is located and the operator to which the mobile phone client belongs. The second determination module 402 may determine, according to the geographical area and the operator, the IP address of the download server. The sending module 403 may send the IP address of the download server to the mobile phone client. Thus, the mobile phone client may obtain a download address by using the IP address of the download server, so as to implement a resource download.

The service server may determine, by using the IP address of the mobile phone client, the geographical area where the mobile phone client is located and the operator to which the mobile phone client belongs. The service server may determine, by using the geographical area and the operator, an IP address of a download server that may provide the mobile phone client with a download service. The service server may subsequently return the IP address of the download server to the mobile phone client. In this solution, a caching function of a domain name resolution server is not used. Accordingly, a success rate and speed of resource downloading by the mobile phone client can be effectively improved.

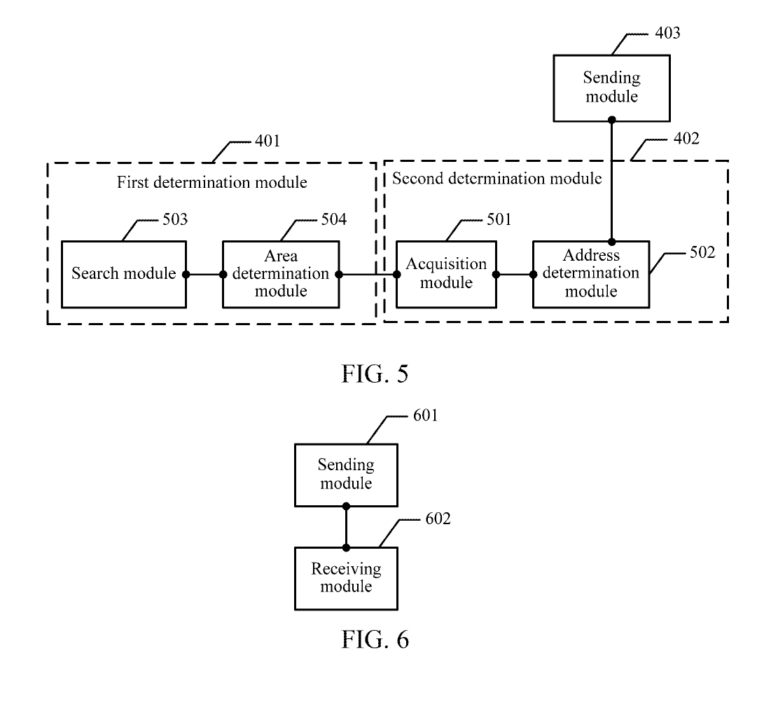

FIG. 5 illustrates another example service server. The second determination module 402 in FIG. 5 may include an acquisition module 501 and an address determination module 502. The acquisition module 501 may identify one or more download servers in a particular geographical area. The address determination module 502 may determine an IP address of a download server. The address determination module 502 may initially determine whether the download server provides a download service to an operator to which the mobile phone client belongs. Alternatively or in addition, the determination module 502 may identify the download server that serves the operator among the obtained one or more download servers.

Alternatively or in addition, the first determination module 401 may include a search module 503, and an area determination module 504. The search module 503 may search IP address segments of operators and determine that an operator corresponding to an address segment including an IP address of the mobile phone client is an operator to which the mobile phone client belongs. The area determination module 504 may determine, according to an area allocated to the IP address segment of the operator, that a geographical area where the IP address of the mobile phone client is located is a geographical area where the mobile phone client is located.

The search module 503 in the first determination module 401 may search, according to the IP address of the mobile phone client received from the mobile phone client, the IP address segments of the operators. The search module 503 may determine that the operator corresponding to IP address segment including the IP address of the mobile phone client is the operator to which the mobile phone client belongs. The area determination module 504 may determine, according to the geographical area allocated to the IP address segment of the operator, that the geographical area where the IP address of the mobile phone client is located is the geographical area where the mobile phone client is located. The acquisition module 501 in the second determination module 402 may identify the one or more download servers in the determined geographical area. The address determination module 502 may determine the IP address of a selected download server, which provides the operator with the download service. The selected download server is from among the identified one or more download servers. The sending module 403 may send the IP address of the selected download server to the mobile phone client. The mobile phone client may obtain a download address by using the IP address of the selected download server, so as to implement a resource download.

The service server may search IP address segments of operators and determine that an operator corresponding to an address segment including an IP address of a mobile phone client is an operator to which the mobile phone client belongs. The service server may accordingly determine, by using the IP address of the mobile phone client, the geographical area where the mobile phone client is located. The service server may determine, by using the obtained operator to which the mobile phone client belongs and the geographical area where the mobile phone client is located, an IP address of a download server that is in the same geographical area as the mobile phone client and belongs to the same operator as the mobile phone client. The service server may subsequently return the obtained IP address of the download server to the mobile phone client in response to the download request from the mobile phone client. Therefore, issues such as a download failure or a slow download speed caused by using a domain name resolution server to perform domain name resolution and acquire an IP address of a download server are avoided by the service server's implementation described throughout the present document. Thus, success rate and speed of resource downloading of the mobile phone client is effectively improved.

FIG. 6 illustrates an example mobile phone client. The mobile phone client may include a sending module 601, and a receiving module 602. The sending module 601 may send an IP address of the mobile phone client to a service server. The receiving module 602 may receive an IP address of a download server fed back by the service server. The IP address of the download server may be determined according to a geographical area where the mobile phone client is located and an operator to which the mobile phone client belongs. The geographical area where the mobile phone client is located and the operator to which the mobile phone client belongs are determined according to the IP address of the mobile phone client.

In an example, the sending module 601 may send a link request to the service server. The link request may include the IP address of the mobile phone client.

FIG. 7 illustrates an example mobile phone client. The mobile phone client in addition to the sending module 601 and the receiving module 602 may include a determination module 603. The determination module 603 may determine a download address according to the IP address of the download server, so as to implement a resource download.

The determination module 603 may include a first determination module 6031 and a second determination module 6032. If the service server provides an IP address of only one download server, the first determination module 6031 may replace a domain name in the download address with the IP address of the download server. The first determination module 6031 may subsequently use the download address to implement a resource download.

If the service server identifies and provides IP address of more than one download server in the geographic area of the mobile phone client, the second determination module 6032 may select one of the download servers. The second determination module 6032 may use the IP address of the selected download server to replace the domain name in the download address to generate the download address for downloading the resource. The second determination module 6032 may select the download server from the download servers identified based on a predetermined criteria such as a geographic distance of the respective download servers from the mobile phone client location, bandwidth capacity of the respective download servers, or other such criteria.

The sending module 601 in the mobile phone client may send an IP address of the mobile phone client to the service server. The IP address of the download server that provides the mobile phone client with a download service may be determined by using the IP address by the service server. The obtained IP address of the download server may be returned to the mobile phone client by the service server. The receiving module 602 in the mobile phone client may receive the IP address of the download server fed back by the service server. The determination module 603 may determine the download address according to the IP address of the download server. The download address may be used to implement a resource download. For example, if an IP address of only one download server exists in the IP address of the download server, the first determination module 6031 in the determination module 603 may replace a domain name in the download address with the IP address of the download server, so as to obtain a download address. If an IP address of more than one download server exists in the IP address of the download server, the second determination module 6032 in the determination module 603 may select an IP address of one download server from the IP address of the more than one download servers to replace the domain name in the download address, so as to obtain the download address.

In an example, the mobile phone client may send an IP address of the mobile phone client to the service server, so that the service server may send, to the mobile phone client, the IP address of the download server that is in the same geographical area as the mobile phone client and belongs to the same operator as the mobile phone client. The mobile phone client may determine a download address by using the received IP address of the download server, so as to implement a resource download. The mobile phone client can thus skip obtaining an IP address of the download server based on DNS resolution by using a domain name resolution server. The mobile phone client may thus avoid a failure in resource downloading of a mobile phone client. The mobile phone client may further download the resource at a higher speed and a better success rate than when using the DNS resolution.

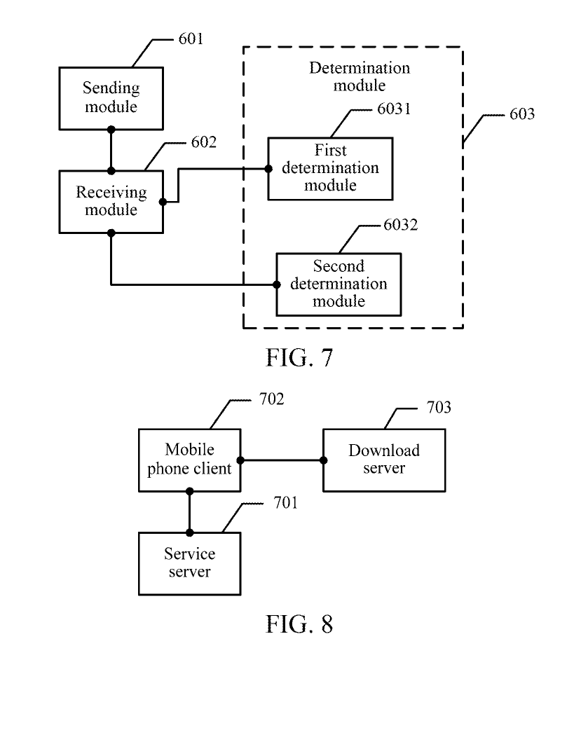

FIG. 8 illustrates an example resource download system. The system may include a service server 701, a mobile phone client 702, and a download server 703. The service server 701, the mobile phone client 702, and the download server 703 may be the respective servers as illustrated in FIG. 4, FIG. 5, FIG. 6, or FIG. 7.

The mobile phone client 702 may send an IP address of the mobile phone client 702 to the service server 701. The service server 701 may determine, by using the IP address of the mobile phone client 702, an IP address of the download server 703. The download server 703 may be in the same geographical area as the mobile phone client 702 and belongs to the same operator as the mobile phone client 702. The service server 701 may send the IP address of the download server 703 to the mobile phone client 702.

After receiving the IP address of the download server 703, the mobile phone client 702 may replace a domain name in a download address with the IP address of the download server 703, so as to obtain a new download address that may be used to download a resource. The mobile phone client 702 may access the download server 703 by using the new download address, so as to implement a resource download.

The mobile phone client 702 may, thus acquire the IP address of the download server 703 form the service server 701. Accordingly, the mobile phone client 702 does not obtain the IP address of the download server 703 through DNS resolution by using a domain name resolution server. Thus, a download speed and success rate of the mobile phone client 702 downloading the resource is improved.

The system in FIG. 7, and each of the service server 701, the mobile phone client 702, and the download server 703, may be implemented in many different ways. Each module, such as the first determination module 401, the second determination module 402, the sending module 601, and the receiving module 602, may be hardware or a combination of hardware and software. For example, each component may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively or in addition, each component may include memory hardware, such as a portion of the memory, for example, that comprises instructions executable with the processor or other processor to implement one or more of the features of the component. When any one of the component includes the portion of the memory that comprises instructions executable with the processor, the component may or may not include the processor. In some examples, each component may just be the portion of the memory or other physical memory that comprises instructions executable with the processor or other processor to implement the features of the corresponding component without the component including any other hardware. Because each module includes at least some hardware even when the included hardware comprises software, each module may be interchangeably referred to as a hardware component, such as the first determination hardware, the second determination hardware, the sending hardware, and the receiving hardware.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device. However, the computer readable storage medium is not a transitory transmission medium for propagating signals.

All of the discussion, regardless of the particular implementation described, is exemplary in nature, rather than limiting. For example, although selected aspects, features, or components of the implementations are depicted as being stored in memories, all or part of the system or systems may be stored on, distributed across, or read from other computer readable storage media, for example, secondary storage devices such as hard disks, flash memory drives, floppy disks, and CD-ROMs. Moreover, the various components and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the logic or instructions are stored in a remote location for transfer through a computer network or over telephone lines. In yet other embodiments, the logic or instructions are stored within a given computer, central processing unit (“CPU”), graphics processing unit (“GPU”), or system.

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same program or apparatus. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, <N>, or combinations thereof” or “<A>, <B>, . . . and/or <N>” are to be construed in the broadest sense, superseding any other implied definitions hereinbefore or hereinafter unless expressly asserted to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A resource download method, comprising:
determining, by a service server, according to an Internet Protocol (IP) address of a mobile phone client obtained from the mobile phone client, a geographical area where the mobile phone client is located and an operator to which the mobile phone client belongs;
determining, by the service server, an IP address of a download server according to the geographical area and the operator; and
sending, by the service server, the IP address of the download server for receipt by the mobile phone client, so as to implement a resource download at the mobile phone client.

2. The resource download method according to claim 1, wherein determining the IP address of the download server according to the geographical area and the operator comprises:
identifying, by the service server, one or more download servers in the geographical area; and
determining, by the service server, an IP address of the download server from among the one or more download servers, based on the download server being configured to provide download service to the operator.

3. The resource download method according to claim 1, wherein determining, according to the IP address of the mobile phone client, the geographical area where the mobile phone client is located and the operator to which the mobile phone client belongs comprises:
identifying, by the service server, the operator to which the mobile phone client belongs based on the operator being an operator corresponding to an address segment that includes the IP address of the mobile phone client; and
determining, by the service server, the geographical area in which the mobile phone client is located based on the IP address segment of the operator being allocated to devices in said geographical area.

4. The resource download method according to claim 1, further comprising: receiving, by the service server, a link request sent by the mobile phone client, wherein the link request comprises the IP address of the mobile phone client.

5. A resource download method, comprising:
sending, by a mobile phone client, an Internet Protocol (IP) address of the mobile phone client to a service server; and
receiving, by the mobile phone client, an IP address of a download server sent by the service server, wherein the IP address of the download server is determined according to a geographical location of the mobile phone client and an operator of the mobile phone client, and wherein the geographical location of the mobile phone client and the operator of the mobile phone client are determined based on the IP address of the mobile phone client.

6. The resource download method according to claim 5, further comprising: sending, by the mobile phone client, a link request to the service server, wherein the link request comprises the IP address of the mobile phone client.

7. The resource download method according to claim 5, further comprising: determining, by the mobile phone client, a download address based on the IP address of the download server, and downloading a resource from the download server using the download address.

8. The resource download method according to claim 7, wherein the download address is a first download address, and wherein determining, by the mobile phone client, the download address based on the IP address of the download server comprises:
determining, by the mobile phone client, a number of download servers identified by the service server;
if only one download server exists, generating, by the mobile phone client, the first download address by replacing a domain name in a second download address that comprises the domain name with the IP address of the download server; and
if more than one download server exists, selecting a download server from the more than one download server, and generating, by the mobile phone client, the first download address by replacing the domain name in the second download address that comprises the domain name, with an IP address of the selected download server.

9. A service server, comprising:
a first determination module, configured to determine, according to an Internet Protocol (IP) address of a mobile phone client received from the mobile phone client, a geographical area where the mobile phone client is located and an operator of the mobile phone client;
a second determination module configured to determine an IP address of a download server according to the geographical area and the operator; and
a sending module configured to send the IP address of the download server to the mobile phone client.

10. The service server according to claim 9, wherein the second determination module comprises:
an acquisition module configured to obtain one or more download servers in the geographical area; and
an address determination module, configured to determine an IP address of a selected download server, the selected download server being the download server, from among the one or more download servers, that provides the operator with a download service.

11. The service server according to claim 9, wherein the first determination module comprises:
a search module configured to search IP address segments of operators and determine the operator of the mobile phone client as an operator corresponding to an address segment that includes the IP address of the mobile phone client; and
an area determination module configured to determine the geographical area of the mobile phone client based on an area allocated to the IP address segment of the operator.

12. The service server according to claim 9, further comprising: a receiving module configured to receive a link request sent by the mobile phone client, wherein the link request comprises the IP address of the mobile phone client.

13. The resource download method according to claim 2, wherein determining, according to the IP address of the mobile phone client, the geographical area where the mobile phone client is located and the operator to which the mobile phone client belongs comprises:
identifying, by the service server, the operator to which the mobile phone client belongs based on the operator being an operator corresponding to an address segment that includes the IP address of the mobile phone client; and
determining, by the service server, the geographical area in which the mobile phone client is located based on the IP address segment of the operator being allocated to devices in said geographical area.

14. The resource download method according to claim 2, further comprising: receiving, by the service server, a link request sent by the mobile phone client, wherein the link request comprises the IP address of the mobile phone client.

15. The service server according to claim 10, wherein the first determination module comprises:
a search module configured to search IP address segments of operators and determine that an operator corresponding to an address segment comprising the IP address of the mobile phone client is the operator to which the mobile phone client belongs; and
an area determination module configured to determine, according to an area allocated to the IP address segment of the operator, that a geographical area where the IP address of the mobile phone client is located is the geographical area where the mobile phone client is located.
